(19) United States
(12) Patent Application Publication
(10) Pub. No.: US 2022/0190567 A1
(43) Pub. Date: Jun. 16, 2022

(54) ELECTRICAL PANEL WIRE ORGANIZATIONAL AND SUPPORT DEVICE

(71) Applicant: David J. Martel, Avon, CO (US)

(72) Inventor: David J. Martel, Avon, CO (US)

(21) Appl. No.: 17/550,561

(22) Filed: Dec. 14, 2021

Related U.S. Application Data
(60) Provisional application No. 63/124,988, filed on Dec. 14, 2020.

(51) Int. Cl. H02G 3/04; H02G 3/22; H02G 1/00

(52) U.S. Cl. CPC H02G 3/0456; H02G 1/00; H02G 3/22

(57) ABSTRACT

A wire organizational device. The wire organizational device including a guide plate disposed between adjacent wall studs to interact with wires extending from an electrical panel to organize and provide support for the wires. A method of installing the wire organizational device includes securing the wire organizational device between two adjacent wall studs and running the wires from the electrical panel to engage with the wire organizational device.

### CROSS-REFERENCE TO RELATED APPLICATIONS

The present application is a conversion of U.S. Provisional Application having U.S. Ser. No. 63/124,988, filed Dec. 14, 2020, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a wire organizational device for use with a load center distribution panel (electrical panel) to arrange and bring order to the various wires extending upward or downward out of the electrical panel.

### 2. Description of the Related Art

An electrical panel is typically installed between two wall studs and wires run upward or downward from the electrical panel between the wall studs. In numerous situations, the wires that extend out of the electrical panel are not held in place in any constructive way. The wires are unorderly and not easily accessible or identifiable. In other situations, the wires are kept somewhat orderly with nails, staples, brackets, and the like.

Accordingly, there is a need for a device that can be used to provide order and accessibility to the wires that extend from the electrical panel.

### SUMMARY OF THE DISCLOSURE

The present disclosure is directed to a wire organizational device. The wire organizational device including a guide plate disposed between adjacent wall studs to interact with wires extending from an electrical panel to organize and provide support for the wires.

The present disclosure is also directed to a method of installing the wire organizational device. The method includes securing the wire organizational device between two adjacent wall studs and running the wires from the electrical panel to engage with the wire organizational device.

### BRIEF DESCRIPTION OF THE DRAWINGS

FIG. 1 is a perspective view of a wire organizational device shown in use and constructed in accordance with the present disclosure.

FIG. 2A is a perspective view of one embodiment of the wire organizational device constructed in accordance with the present disclosure

FIG. 2B is yet another perspective view of the wire organizational device shown in FIG. 2A constructed in accordance with the present disclosure.

FIG. 3A is a perspective view of another embodiment of the wire organizational device constructed in accordance with the present disclosure

FIG. 3B is another perspective view of the wire organizational device shown in FIG. 3A constructed in accordance with the present disclosure.

FIG. 3C is yet another perspective view of the wire organizational device shown in FIG. 3A constructed in accordance with the present disclosure.

### DETAILED DESCRIPTION OF THE DISCLOSURE

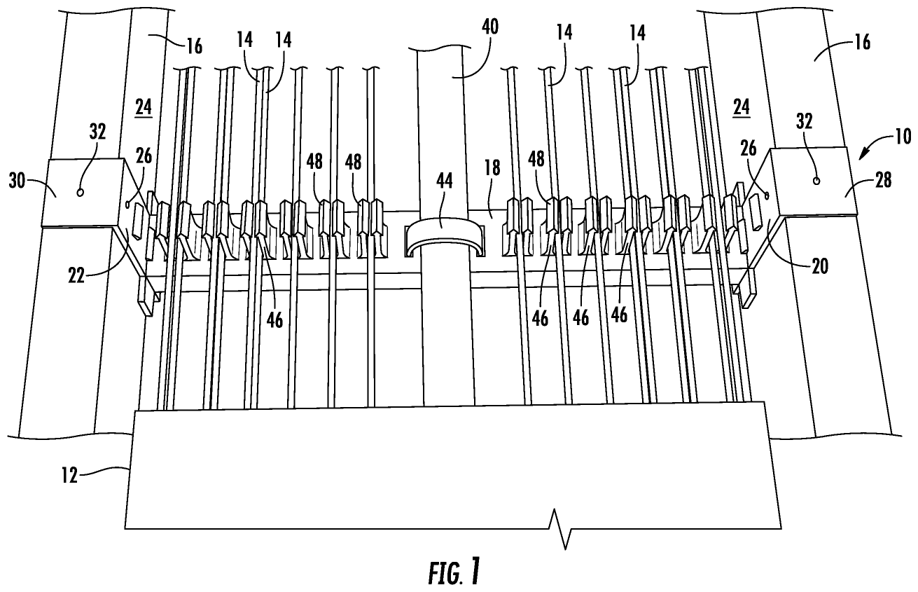

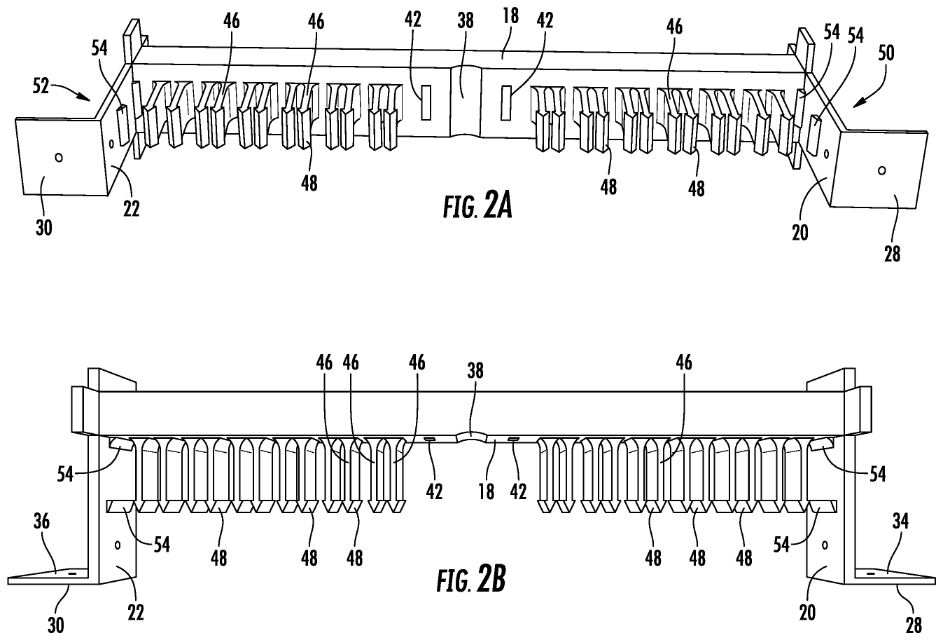

Referring now to FIGS. 1-2C, shown therein is a wire organizational and support device 10 that can be used with a load center distribution panel (electrical panel) 12 to provide order to the wires 14 that extend upward or downward out of the electrical panel 12. Multiple wire organizational devices 10 can be used to maintain order of the wires 14 running out of the electrical panel 12. The wire organizational devices 10 are configured to be secured between adjacent wall studs 16 above or below the electrical panel 12 disposed between the same adjacent wall studs 16.

The wire organizational device 10 includes a guide plate 18 having a first stud plate 20 disposed on one end of the guide plate 18 and a second stud plate 22 disposed on the other end of the guide plate 18. The guide plate 18 is used to interact with the wires 14 to provide structured arrangement of the wires 14 extending from the electrical panel 12. The first and second stud plates 20 and 22 are substantially vertically disposed so that they can be secured to the inside of adjacent wall studs 16. The first and second stud plates 20 and 22 can be secured to the inside 24 of the wall studs 16 in any manner known in the art, such as with nails and or screws. In one embodiment, the first and second stud plates 20 and 22 can include at least one opening 26 therein to permit a nail or screw to be used to secure the wire organizational device 10 to the adjacent wall studs 16.

In a further embodiment of the present disclosure, the first and second stud plates 20 and 22 include a first flange plate 28 and a second flange plate 30 that extends outwardly from the first and second stud plates 20 and 22, respectively. The first and second flange plates 28 and 30 can engage a front or back of a wall stud 16 to better secure the wire organizational device 10 between the two adjacent wall studs 16. Similar to the first and second stud plates 20 and 22, the first and second flange plates 28 and 30 can be secured to the wall studs 16 in any manner known in the art. For example, the first and second flange plates 28 and 30 can include one or more holes 32 therein for a screw or nail to be used to secure the first and second flange plates 28 and 30 to the front or back of a wall stud 16.

In one embodiment of the present disclosure, the guide plate 18 can be vertically disposed and attached at back portions 34 and 36 of the first and second stud plates 20 and 22. The guide plate 18 can include a recessed area 38 vertically disposed in the guide plate 18 for receiving a portion of a service entrance cable 40. The guide plate 18 can also include openings 42 disposed adjacent to the recessed area 38 to permit securing means 44 to pass therethrough and secure the service entrance cable 40 to the recessed area 38 of the guide plate 18. The guide plate 18 can also include multiple extension elements 46 that extend laterally from the guide plate 18 and toward the space between the wall studs 16 and above the electrical panel 12. The wires 14 running to and from the electrical panel 12 are run into and through the space between the various extension elements 46 to organize the wires 14 in an orderly manner. One end of the extension elements 46 are attached to the guide plate 18 and the other end of the extension elements 46 include a bulbous end 48. The bulbous ends 48 of the extension elements 46 cooperate to hold the wires 14 in the space between the extension elements 46. The bulbous ends 48 can have any desirable shape so that wires 14 placed between adjacent extension elements 46 meet some resistance from the bulbous ends 48 during placement of the wires 14 and removal of the wires 14. For example, the bulbous ends 48 can be rounded, triangular shaped, etc.

The extension elements 46 have the ability to flex laterally, thus adjacent extension elements 46 can be flexed away from each other—the corresponding adjacent bulbous ends 48 flexed away from each other too—to permit wires 14 to be placed therebetween. After the wires 14 have been placed between adjacent extension elements 46, the extension elements 46 will move back to their natural positions and the bulbous ends 48 will retain the wires 14 between the adjacent extension members 46. The wires 14 would only be able to be withdrawn from between the extension elements 46 by force from a user, such as an electrician.

The space between adjacent extension elements 46 can be varied to accommodate various sized wires 14 that can be used. In a further embodiment, the inside portions 50 and 52 of the stud plates 20 and 22, respectively, can include protrusions 54 that are in general alignment with the bulbous head 48 positioned adjacent thereto. The protrusions 54 cooperate with the respective adjacent bulbous head 48 in a similar fashion as the adjacent bulbous heads 48 described herein.

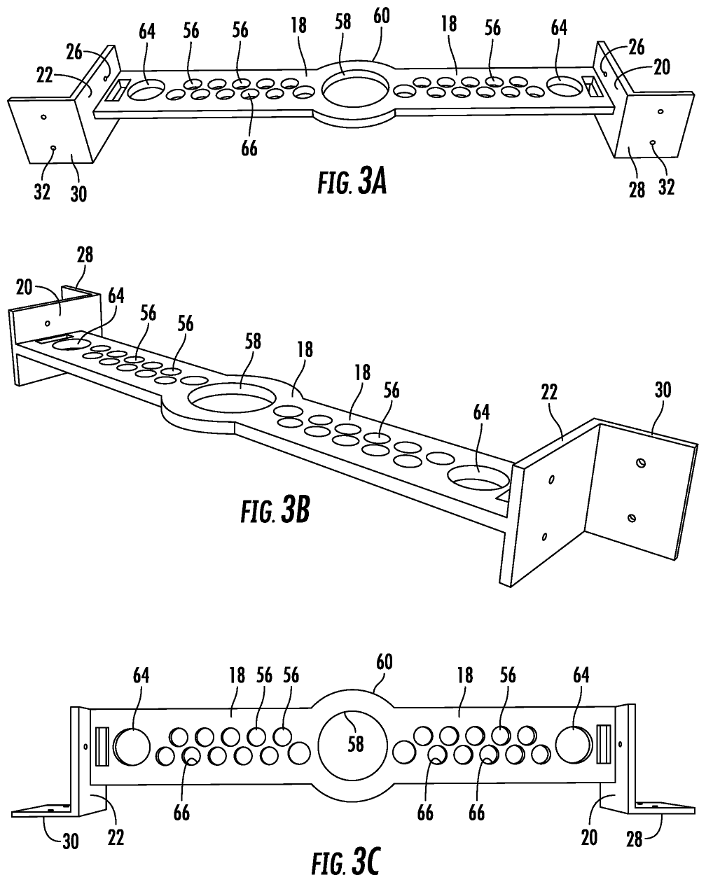

Referring now to FIGS. 3A-3C, shown therein is another embodiment of the present disclosure. In this embodiment, the guide plate 18 can be horizontally disposed between the stud plates 20 and 22. In this embodiment, the guide plate 18 can have a series of openings 56 disposed therein to receive the wires 14 extending from the electrical panel 12. In one embodiment, the guide plate 18 can include a large opening 58 disposed therein to receive the service entrance cable 40 and maintain the position of the service entrance cable 40 in the space between the adjacent wall studs 16. The large opening 58 can be disposed in the approximate center of the guide plate 18 because that is generally where the service entrance cable 40 extends out of the electric panel 12. The guide plate 18 can have a wide portion 60 with an increased width at the area where the large opening 58 is disposed so that the service entrance cable 40 can have a sufficient amount of plate surrounding it so that the service entrance cable 40 is secure in the guide plate 12. At the edges 62 of the guide plate 18 adjacent to the stud plates 20 and 22, the guide plate 18 can include medium sized openings 64 to permit the passage of wires 14 that need a medium sized opening to pass through. Further, the guide plate 18 can include numerous smaller holes 66 disposed in the guide plate 18 to permit more commonly used sizes of wires 14 to pass therethrough. It should be understood and appreciated that while three sizes of openings are described herein for this embodiment, the guide plate can have any various of opening sizes so that the wire organizational device can properly organize and secure the wires in place.

In another embodiment, the guide plate 18 can be comprised of multiple parts that are hingedly connected to permit access to the openings 56, 58, 64 and 66 in the event repairs or rewiring needs to occur. The separate parts of the guide plates 18 can each be selectively securable to the other separate parts making up the guide plate 18.

In a further embodiment of the present disclosure, a method of installing the wire organizational device 10 is provided. The wire organizational device 10 can be inserted between two adjacent wall studs 16 and secured thereto. Wires 14 can be run from the electrical panel 12 to engage with the wire organizational device 10 in the manner described herein.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made, and combinations of the various embodiments can be comprised, which will readily suggest themselves to those skilled in the art and which are accomplished within the spirit of the disclosure and claims.

What is claimed is:

1. A wire organizational device, the wire organizational device comprising:
a guide plate disposed between adjacent wall studs to interact with wires extending from an electrical panel to organize and provide support for the wires.

2. The wire organizational device of claim 1 further comprising a first stud plate secured to one end of the guide plate and a second stud plate secured to the other end of the guide plate, the first and second stud plates secure the wire organizational device to inside surfaces of the adjacent wall studs above or below an electrical panel.

3. The wire organizational device of claim 2 wherein the first stud plate includes a first flange plate that extends perpendicularly therefrom and securable to a front or back side of one of the adjacent wall studs.

4. The wire organizational device of claim 3 wherein the second stud plate includes a second flange plate that extends perpendicularly therefrom and securable to a front or back side of the other adjacent wall stud.

5. The wire organizational device of claim 4 wherein first and second stud plates and the first and second flange plates can include openings therein for permitting securing devices to extend therethrough to secure the wire organizational device to the adjacent wall studs.

6. The wire organizational device of claim 1 wherein the guide plate is vertically disposed and further comprises a plurality of extension elements extending therefrom that the wires can pass between, the extension elements limit lateral movement of the wires.

7. The wire organizational device of claim 6 further comprising bulbous ends disposed on ends of the extension elements to resistance to lateral movement of the wires in a particular direction when the wires are disposed between two adjacent extension elements.

8. The wire organizational device of claim 7 wherein the bulbous ends are rounded or triangular shaped.

9. The wire organizational device of claim 1 wherein the wherein the guide plate is horizontally disposed and further comprises a plurality of openings disposed therein that the wires can extend therethrough, the openings limit lateral movement of the wires.

10. The wire organizational device of claim 9 wherein the guide plate has a wider portion to accommodate a larger opening so a service entrance cable can be extended therethrough.

11. The wire organizational device of claim 9 wherein the openings disposed in the guide plate can be varied in size to accommodate various sized wires.

12. The wire organizational device of claim 6 further comprising a recessed area disposed in the guide plate to accommodate a service entrance cable.

13. A method of installing a wire organizational device, the method comprises:
securing the wire organizational device between two adjacent wall studs, the wire organizational device comprising:
a guide plate disposed between adjacent wall studs to interact with wires extending from an electrical panel to organize and provide support for the wires;
running wires from the electrical panel to engage with the wire organizational device.

14. The method of claim 13 wherein the wire organizational device further comprises:
a first stud plate secured to one end of the guide plate, the first stud plate includes a first flange plate that extends perpendicularly therefrom and securable to a front or back side of one of the adjacent wall studs; and
a second stud plate secured to the other end of the guide plate, the second stud plate includes a second flange plate that extends perpendicularly therefrom and securable to a front or back side of the other adjacent wall stud, the first and second stud plates secure the wire organizational device to inside surfaces of the adjacent wall studs above or below an electrical panel wherein.

15. The method of claim 13 wherein the guide plate is vertically disposed and further comprises a plurality of extension elements extending therefrom that the wires can pass between, the extension elements limit lateral movement of the wires.

16. The method of claim 15 further comprising bulbous ends disposed on ends of the extension elements to resistance to lateral movement of the wires in a particular direction when the wires are disposed between two adjacent extension elements.

17. The method of claim 13 wherein the wherein the guide plate is horizontally disposed and further comprises a plurality of openings disposed therein that the wires can extend therethrough, the openings limit lateral movement of the wires.

18. The method of claim 17 wherein the guide plate has a wider portion to accommodate a larger opening so a service entrance cable can be extended therethrough.

19. The method of claim 18 wherein the openings disposed in the guide plate can be varied in size to accommodate various sized wires.

20. The method of claim 15 further comprising a recessed area disposed in the guide plate to accommodate a service entrance cable.
